(19) United States
(12) Patent Application Publication
(10) Pub. No.: US 2011/0219692 A1
(43) Pub. Date: Sep. 15, 2011

(54) DUAL SLIDABLE SHUTTER ASSEMBLY

(76) Inventor: Viken Ohanesian, San Juan Capistrano, CA (US)

(21) Appl. No.: 13/046,223

(22) Filed: Mar. 11, 2011

Related U.S. Application Data
(60) Provisional application No. 61/340,077, filed on Mar. 12, 2010.

(51) Int. Cl. E06B 7/092; E06B 7/086

(52) U.S. Cl. 49/77.1; 49/87.1

(57) ABSTRACT

Light-weight, narrow-profile, bypass sliding shutter systems is disclosed. The shutter system has a dual-track headrail and an inner and outer shutter assembly having louvers. The inner shutter assembly and the outer shutter assembly are configured to move past each other when the louvers in the inner and outer shutters are in a closed position. The shutter systems are lightweight and are for an inside window mount.

### RELATED APPLICATIONS

This application relates to, claims priority from, and incorporates herein by reference, as fully set forth, U.S. Provisional Patent Application Ser. No. 61/340,077 filed on Mar. 12, 2010 and titled “ALLVIEW LOUVERS.”

### BACKGROUND OF THE INVENTION

1. Field of the Invention

The present invention relates in general to indoor window shutters. More particularly, the invention is directed to indoor bypass sliding window shutters having interconnected louvers.

2. Description of the Related Art

Shutters are a popular window treatment because they provide a crisp, architectural appearance that can enhance a room's appearance while providing excellent light control and privacy. However, traditional shutters are expensive and have significant costs associated with their framing, hinging, finishing, and installation.

Accordingly, a need exists to reduce the costs associated with shutters.

### SUMMARY OF THE INVENTION

In a first aspect, a shutter system is provided. The shutter system comprises a headrail having an inner track and an outer track, where the headrail is configured for mounting indoors, and an inner shutter assembly having a plurality of first louvers, where the inner shutter assembly is slideably coupled to the inner track. The shutter system further comprises an outer shutter assembly having a plurality of second louvers. The outer shutter assembly is slideably coupled to the outer track. The inner shutter assembly and the outer shutter assembly are configured for moving past each other when the first louvers and the second louvers are placed in a closed position.

In a first preferred embodiment of the shutter system, the headrail, the inner shutter assembly, and the outer shutter assembly are configured for installing within a conventional window opening. The overall depth of the inner shutter assembly and the outer shutter assembly is preferably approximately 2.5 inches or less. The headrail is preferably further configured for mounting in a conventional vertical blind bracket. The headrail preferably further comprises an extruded aluminum member and the inner and outer shutter assemblies preferably further comprise extruded plastic members.

The plastic members preferably further comprise polyresin members. The inner and the outer shutter assembly preferably have a weight in the range of approximately 1.2 pounds/foot² to approximately 2 pounds/.foot² of facial area of a front surface of the inner or outer shutter assemblies. The shutter system preferably has two carrier assemblies coupled to the inner shutter assembly and configured for riding in the inner track, where the two carrier assemblies have a plurality of wheels configured for riding on the lowermost portion of the inner track, and two additional carrier assemblies coupled to the outer shutter assembly and configured for riding in the outer track, where the two additional carrier assemblies have an additional plurality of wheels configured for riding on the lowermost portion of the outer track. The shutter system preferably has a valance configured for coupling to the headrail.

The headrail is preferably further configured for mounting in a conventional window-treatment mounting bracket. No hinge is preferably coupled to the inner shutter assembly or the outer shutter assembly. No frame is preferably coupled to the inner shutter assembly or the outer shutter assembly.

In a second aspect, a shutter assembly is provided. The shutter assembly has a plurality of louvers. Each louver is configured for rotating about an axis of rotation. Each louver has a single male connector louver endcap at one end of said each louver and a dual male connector louver endcap at the opposite end of said each louver. Each single male connector louver endcap comprises a first centrally-located pin protruding away from said each louver in a first direction substantially parallel to the axis of rotation. Each dual male connector louver endcap comprises a second centrally-located pin protruding away from said each louver in a second direction opposite the first direction substantially parallel to the axis of rotation. Each dual male connector louver endcap further comprises a tab at a distal end of said dual male connector louver endcap extending away from the louver. Each tab further comprises a tension pin positioned away from the louver and protruding away from said each louver in the second direction.

The shutter assembly also has a top rail, a bottom rail, and a first stile having a plurality of stile holes configured for receiving corresponding first centrally-located pins from said each single male connector louver endcap. The shutter assembly also has a second stile having a plurality of additional stile holes configured for receiving corresponding second centrally-located pins from said each dual male connector louver endcap, and, a tilt rod having a plurality of tilt rod holes configured for receiving corresponding tension pins from said each dual male connector louver endcap.

In a second preferred embodiment, the second stile has rabbet on a surface adjacent to the dual male connector louver endcaps, and the rabbet is configured for nesting the tilt rod when the louvers are closed. The tilt rod is preferably flush with the surface adjacent to the dual male connector louver endcaps when the louvers are closed. The single male connector louver endcap, the dual male connector louver endcap, the first and second stiles, and the tilt rod are preferably configured for securing the louvers in a desired position and allowing the louvers to be manually adjusted.

The depth of the shutter assembly is preferably approximately 1.125 inch or less. The louvers and the shutter frame preferably comprise hollow extruded plastic members. The extruded plastic members preferably comprise extruded polyresin members. The shutter assembly has a weight in the range of approximately 1.2 pounds/foot² to approximately 2 pounds/foot² of facial area of the shutter assembly.

In a third aspect, a shutter system is provided. The shutter system has a headrail having an inner track, an outer track, and a mounting rail, where the headrail is configured for mounting as an inside window mount. The shutter system has an inner shutter assembly having a first shutter frame having a first set of two stiles, a plurality of first louvers rotatably mounted in the first shutter frame, a first tilt rod coupled to the plurality of first louvers, where the first tilt rod is configured for setting a tilt of the plurality of first louvers, and a first carrier assembly coupled to the first shutter frame and configured for riding in the inner track. The shutter system has an outer shutter assembly having a second shutter frame having a second set of two stiles, a plurality of second louvers rotatably mounted in the second shutter frame, a second tilt rod coupled to the plurality of second louvers, where the second tilt rod is configured for setting a tilt of the plurality of second louvers, and a second carrier assembly coupled to the second shutter frame and configured for riding in the outer track. The inner shutter assembly and the outer shutter assembly are configured for moving past each other when the plurality of first louvers and the plurality of second louvers are placed in a closed position.

In a third preferred embodiment, at least one of the first set of two stiles has a first rabbet on a surface adjacent to the plurality of first louvers, where the first rabbet is further configured for nesting the first tilt rod when the plurality of first louvers are closed, and at least one of the second set of two stiles has a second rabbet on a surface adjacent to the plurality of second louvers, where the second rabbet is further configured for nesting the second tilt rod when the plurality of second louvers are closed. The headrail, the inner shutter assembly, and the outer shutter assembly are preferably configured for fitting within a conventional window opening. No hinge is preferably coupled to the inner shutter assembly or to the outer shutter assembly. No frame is preferably coupled to the inner shutter assembly or to the outer shutter assembly.

In a fourth aspect, a shutter apparatus is provided. The shutter apparatus has a headrail having an inner track and an outer track, where the headrail is configured for coupling to one or more conventional window-treatment mounting brackets. The shutter apparatus has an inner shutter assembly having a plurality of first louvers, where the inner shutter assembly is slideably coupled to the inner track. The shutter apparatus has an outer shutter assembly having a plurality of second louvers, where the outer shutter assembly is slideably coupled to the outer track. The headrail, the inner shutter assembly, and the outer shutter assembly are configured for retrofitting into an existing window-treatment.

In a fourth preferred embodiment, the conventional window-treatment mounting brackets comprise vertical blind mounting brackets, and the existing window-treatment comprises an existing vertical blind. The existing window treatment preferably comprises a window treatment for a sliding glass door. The existing window treatment preferably comprises a window treatment for a window.

These and other features and advantages of the invention will become more apparent with a description of preferred embodiments in reference to the associated drawings.

### DESCRIPTION OF THE DRAWINGS

FIG. 1 is a front (interior facing), perspective view of a preferred embodiment of a shutter system.

FIG. 2 is a back (exterior facing), perspective view of the preferred embodiment of the shutter system illustrating the louvers in an open position.

FIG. 3A is a back, perspective view of the preferred embodiment of the shutter system illustrating the louvers in a closed position.

FIG. 3B is a back, perspective view of the preferred embodiment of the shutter system illustrating that the tilt rod nests in a rabbet formed in the stile.

FIG. 4 is an exploded, perspective view of the preferred embodiment of the shutter and the headrail.

FIG. 5 is a cross-sectional, side view of the preferred embodiment of the shutter and the headrail illustrating the narrow profile of the shutter when the louvers are closed.

FIG. 6 is a cross-sectional, side view of the preferred embodiment of the shutter and the headrail when the louvers are open.

FIG. 7 is an exploded top view of the preferred embodiment of a louver with louver endcaps.

FIG. 8 is a perspective view of the preferred embodiment of a tilt rod and a louver endcap having a centrally-located pin and a tab with a tension pin.

FIG. 9 is a perspective view of the preferred embodiment of a louver endcap having a centrally-located pin.

FIG. 10 is a cutaway, perspective drawing of a louver engaging with the stile and the tension rod.

FIG. 11 is a front (interior facing) perspective drawing of the preferred embodiment of the shutter system installed within a conventional window opening.

FIG. 12 is a front (interior facing) perspective drawing of a preferred embodiment of a shutter apparatus installed near a sliding glass door.

FIG. 13 is a front (interior facing) perspective drawing of an embodiment of a shutter assembly mounted to a frame.

### DETAILED DESCRIPTION OF THE PREFERRED EMBODIMENTS

The following preferred embodiments are directed to lightweight, narrow-profile, sliding shutter systems that are configured for mounting indoors as a window treatment. Such shutter systems are useful for controlling light and providing privacy in homes and offices. The shutter system comprises a dual-track headrail and two bypass shutter assemblies having louvers. The shutter system is fabricated from lightweight, extruded materials and is therefore much lighter than conventional shutter systems. As such, these shutter systems employ a headrail that clips into conventional vertical blind brackets, which enable the shutter systems to retrofit into existing window treatments such as vertical blinds. Preferred embodiments of the shutter system employ narrow-profile shutter assemblies which can fit into conventional window openings. The shutter assemblies employ tilt rods which interconnect the louvers. The tilt rod nests within a rabbet on the adjacent stile when the louvers are closed so that the tilt rod is flush with the back surface of the stile. The tilt rod provides sufficient tension to the louvers such that the louvers are held in place but are easily moved to open or close the louvers.

Conventional shutter systems are typically expensive and have significant costs associated with the framing, hinging, finishing, and installation of the shutters. The following preferred embodiments of the shutter systems are less expensive than conventional shutter systems because the embodiments are directed to pre-finished products that have an appearance of conventional shutters but do not incur the costs associated with framing, hinging, and painting. Moreover, because light-weight materials are used to form the shutter systems, these shutter systems employ a headrail system that clips into conventional vertical blind mounting brackets such as those used for vertical blinds. As a result, the preferred embodiments for installed shutter systems may exhibit a cost savings exceeding 25% as compared to conventional shutter systems.

Conventional bypass shutter systems cannot be installed in typical window openings having a 2½ inch depth because conventional systems require wider framing. The following preferred embodiments of the shutter systems have a slim, narrow-profile which enables them to be placed within conventional window openings and prevents the shutter systems from projecting excessively into an interior room.

As used throughout the specification, “front” refers to an interior facing direction (i.e., facing an interior of a building) or a location farther away from the window, while “back” or “rear” refers to an exterior facing direction (i.e., facing exterior of building) or a location closer to the window. Thus, “front,” “rear” and other positional terms refer to the perspective of one located within the building. In addition, “outer shutter assembly” refers to the shutter assembly farther away from the window, while “inner shuttle assembly” refers to the shutter assembly closest to the window.

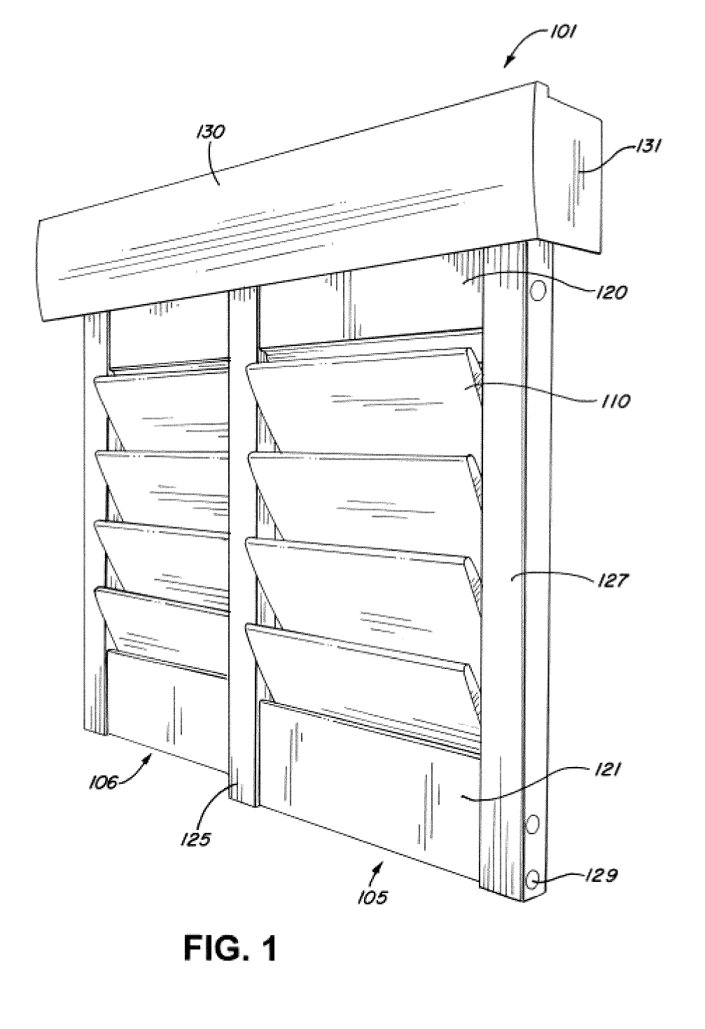

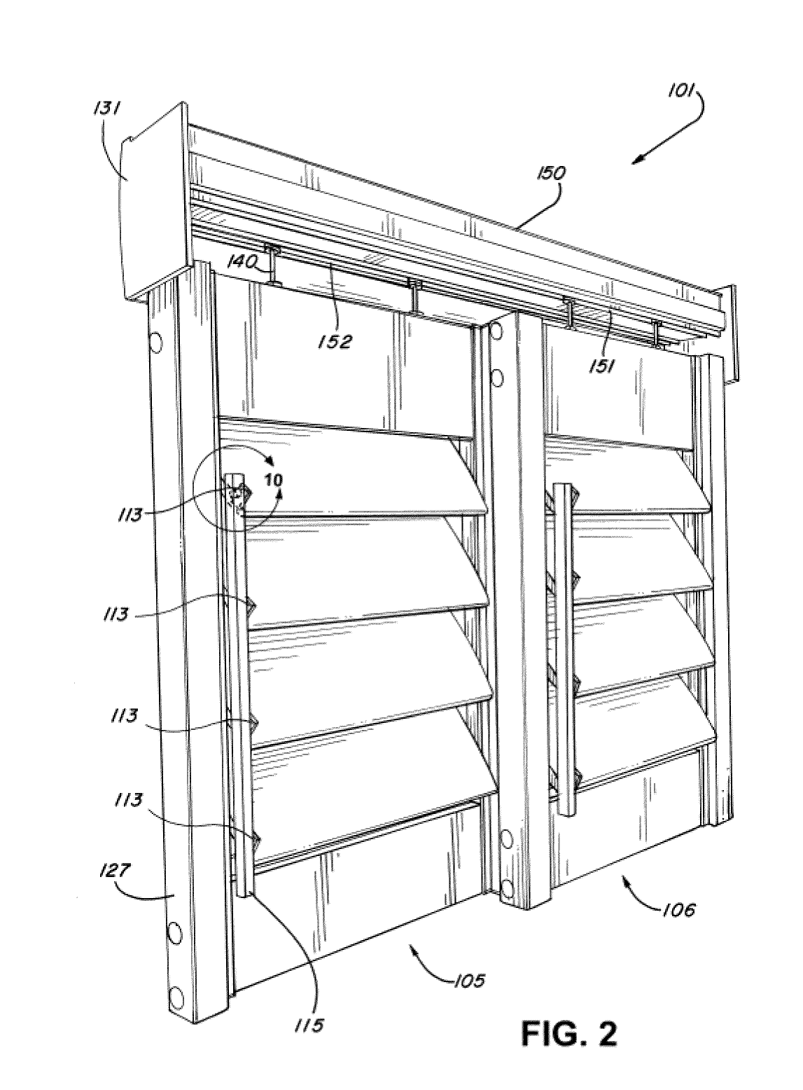

FIG. 1 is a front, perspective view of a preferred embodiment of a shutter system 101. The shutter system 101 has a first outer shutter assembly 105 (i.e., a front shutter panel) and a second inner shutter assembly 106 (i.e. a rear shutter panel). The outer shutter assembly 105 has stiles 125 and 127 which are coupled together by a top rail 120 and a bottom rail 121. The screw hole covers 129 hides the screws that join the stiles 125 and 127 to the rails 120 and 121 and acts as a cushion for adjacent shutter assemblies on the same track. The use of the screw hole cover 129 is optional and may not be used in embodiments which employ painted screws. Louvers 110 are pivotally coupled to the stiles 125 and 127. The valence 130 and the valence endcap 131 provide a decorative window treatment and cover the headrail 150 depicted in FIG. 2. The tilt of the louvers 110 is adjusted by manually moving the louvers to the desired position. Unlike some conventional shutters, neither the inner shutter assembly 106 nor the outer shutter assembly 105 is coupled to a hinge in an embodiment. Unlike some conventional shutters, neither the inner shutter assembly 106 nor the outer shutter assembly 105 is coupled to a frame in an embodiment. As discussed above, the elimination of hinges and framing reduces costs of shutter system 101. While inner shutter assembly 105 depicts four louvers 110 in this non-limiting example, it shall be understood that shutter assemblies having one or more louvers is contemplated in preferred embodiments.

FIG. 2 is a back, perspective view of the preferred embodiment of the shutter system 101 illustrating the louvers in a partially open position. Each louver 110 within the shutter assembly 105 is coupled to a tilt rod 115 through a male tab 113 extending from a dual male connector louver endcap 111 as depicted in FIG. 8 and discussed below. The tilt rod 115 is preferably located at the back and positioned at the side of the louvers 110 adjacent to a stile 127 which enables minimal rearward projection beyond the louvers and provides an open and unobstructed view. The louvers 110, the tabs 113, and the tilt rod 115 are designed to create tension such that the louvers 110 remain in placed but are easily manually moved. In an embodiment, the tilt rod 115 may be placed at the front of the shutter system 101.

Each shutter assembly 105, 106 has at least one, but preferably a pair of, corresponding carrier assemblies 140 that ride in a separate track 152 and 151, respectively, of the headrail 150. Each shutter assembly 105, 106 can therefore pass by the other by closing the louvers 110 in both shutter assemblies 105 and 106 and sliding one or both shutter assemblies 105 and 106 to the desired position.

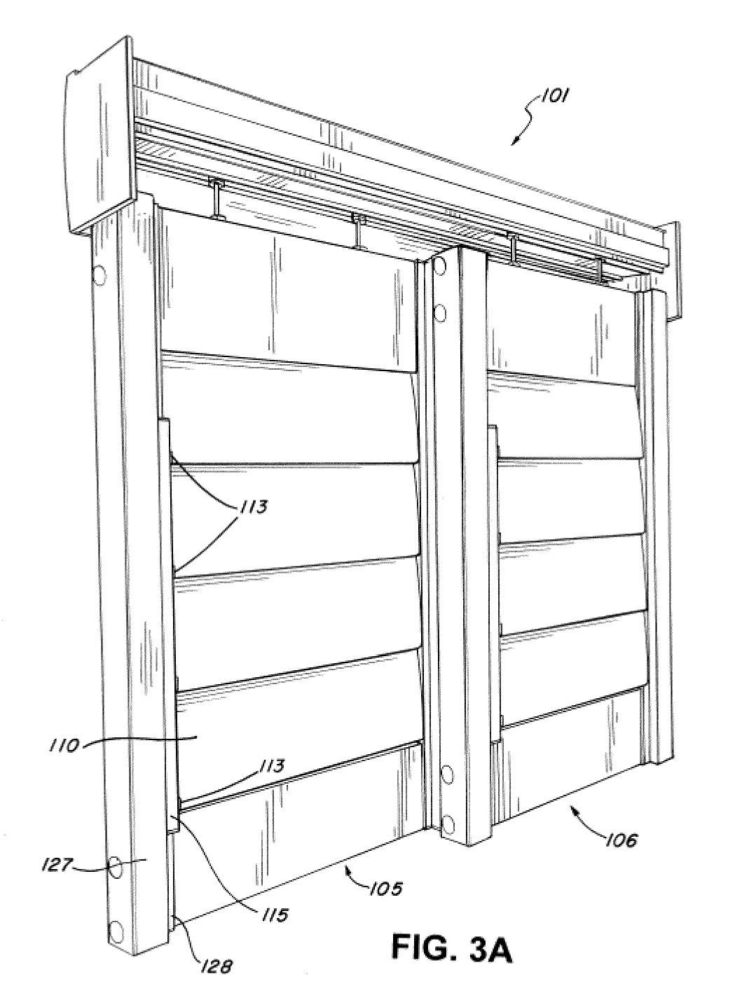

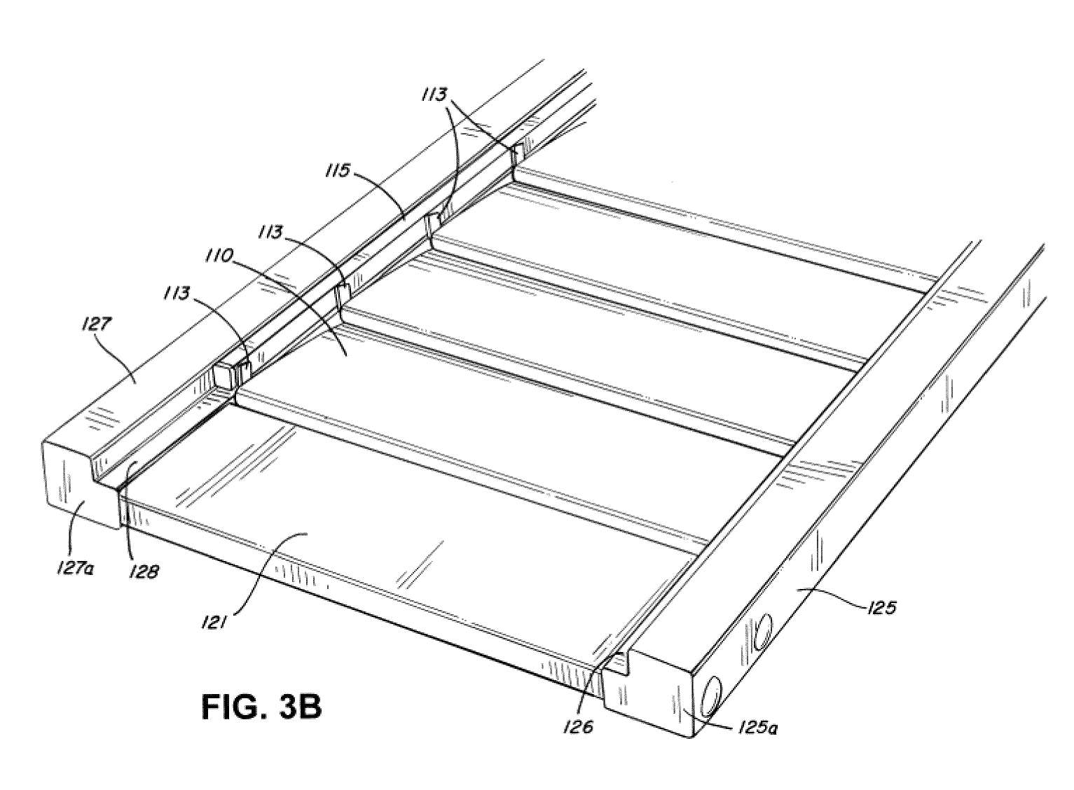

FIG. 3A is a back, perspective view of the preferred embodiment of the shutter system illustrating the louvers 110 placed in a closed position. Stile 127 has a rabbet, or recessed shoulder, 128 immediately adjacent to the louvers 110. When the louvers 110 are in the closed position, the tilt rod 115 nests in the rabbet 128 such that the tilt rod 115 is flush with, or recessed within, the back surface of stile 127. In other words, the tilt rod 115 does not protrude beyond the back surface of stile 127 when nested in this closed position, thereby facilitating smooth and unobstructed bypass of the dual shutter assemblies 105, 106. FIG. 3B is another perspective view of the shutter assembly that illustrates the tilt rod 115 nesting in the rabbet 128. Stile 125 preferably also has a rabbet 126 to provide a symmetrical appearance. FIG. 3B depicts stiles 125 and 127 having stile endcaps 125a and 127a respectively. The stile endcaps 125a and 127a are preferably flush with the rail 121 and do not protrude above or below the stiles 125 and 127.

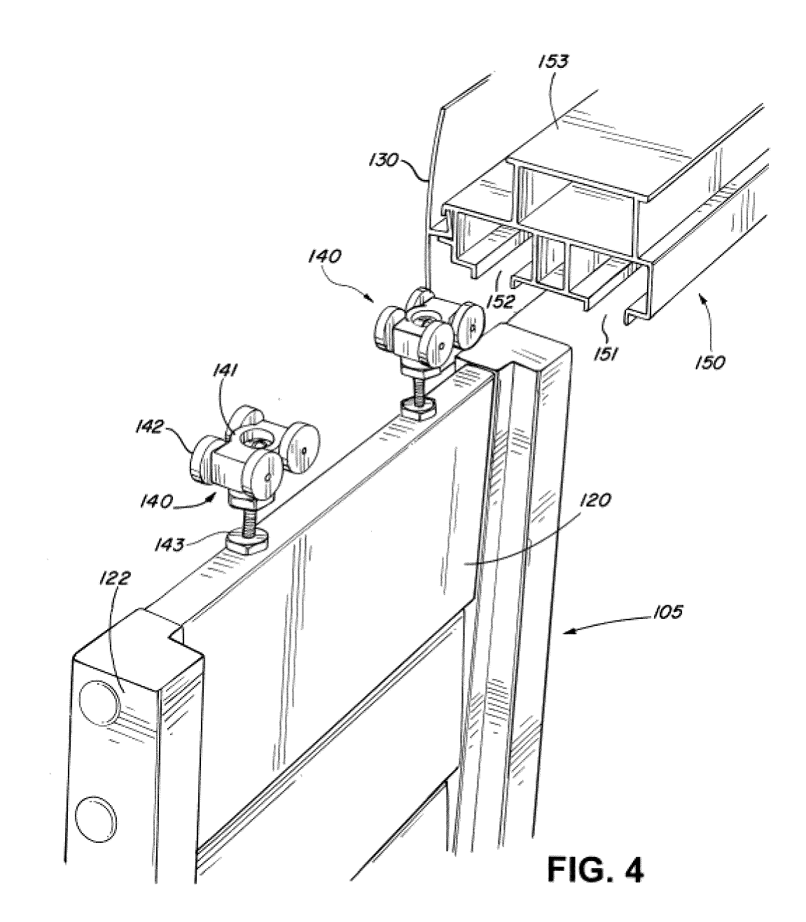

FIG. 4 is an exploded, perspective view of the preferred embodiment of the outer shutter assembly 105 and the headrail 150. Two carrier assemblies 140 are attached to the top rail 120 of the outer shutter assembly 105 by bolts 143. The carrier assemblies 140 each have a carrier housing 141 coupled to carrier wheels 142. The headrail 150 has an inner track 151 and an outer track 152 which are configured to receive carrier assemblies 140. The carrier wheels 142 ride within the track 152 of the headrail 150. Headrail 150 also has a mounting track 153 which is designed to be received by conventional mounting brackets commonly employed for holding venetian blinds and other window treatments.

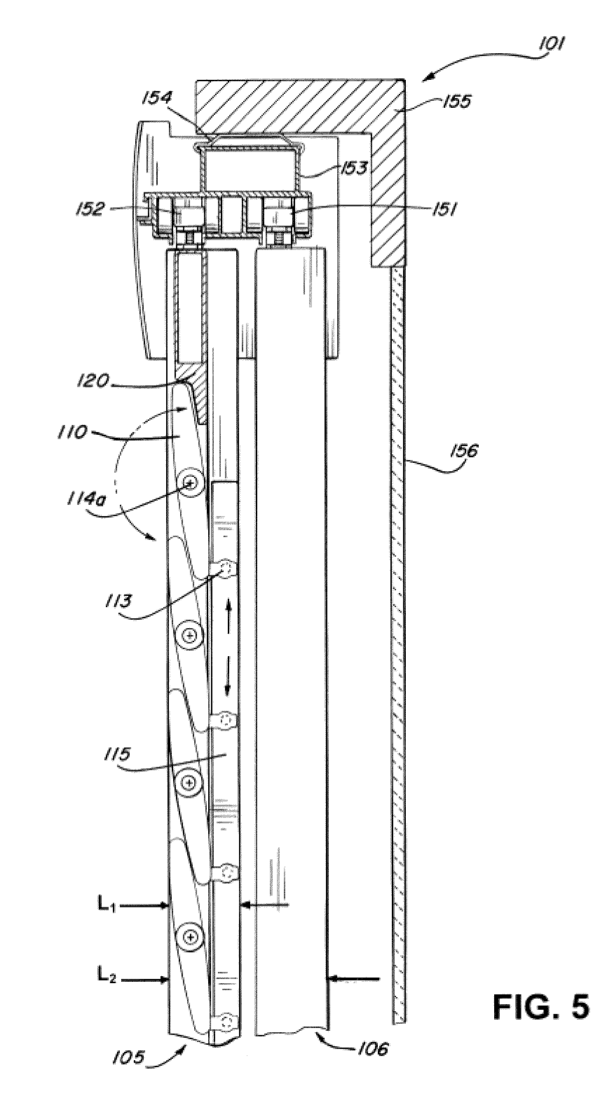

FIG. 5 is a cross-sectional, side view of the preferred embodiment of the shutter system 101 mounted in a conventional window-treatment mounting bracket 154. The narrow-profile of the shutter system 101 enables the outer and inner shutter assemblies 105 and 106 to be mounted within a typical window opening. A conventional window-treatment mounting bracket 154, such as those used to install venetian blinds, is positioned at the appropriate distance from the window 156 and secured to the window jamb 155. The mounting track 153 of the headrail 150 snaps into place and is held by the conventional window-treatment mounting bracket 154. The outer and inner shutter assemblies 105 and 106 hang from and ride in the outer and inner tracks 152 and 151 respectively. The depth of the shutter system 101 is less than conventional shutter systems. The depth (or thickness) of the outer shutter assembly 105, represented by L₁ in FIG. 5, is preferably 1.125 inches or less. The overall depth of the outer and inner shutter assemblies 105 and 106, represented by L₂ in FIG. 5, is preferably 2.5 inches or less. The overall depth of the shutter system 101 having a valance 130 is preferably 2.75 inches or less.

The shutter system 101 is fabricated from extruded, lightweight materials which enable the shutter system 101 to be hung from conventional window-treatment mounting brackets 154 such as those used to install venetian blinds, vertical blinds, horizontal blinds, and mini blinds. As such, the shutter system 101 may be used to retrofit into existing window treatments including, but not limited to, venetian blinds, vertical blinds, horizontal blinds, and mini blinds.

The headrail 150 is preferably an extruded, lightweight metal such as aluminum. The stiles 125 and 127, the rails 120 and 121, and the louvers 110 may be extruded and fabricated out of lightweight materials such as plastics and polyresin. The interior of the stiles 125, 127, the rails 120, 121, and the louvers 110 may be hollow or filled with lightweight materials such as wood composites. As such, the outer and inner shutter assemblies 105 and 106 have a weight in the range of approximately 1.2 pounds/foot² to approximately 2 pounds per foot² of the facial area of the shutter assemblies 105 and 106. The outer and inner shutter assemblies 105 and 106 have a weight preferably 1.5 pounds/foot² or less of the facial area of the shutter assemblies 105 and 106 configured to cover a large opening such as a door for example. The outer and inner shutter assemblies 105 and 106 have a weight preferably 2.0 pounds/foot² or less of the facial area of the shutter assemblies 105 and 106 configured to cover smaller openings such as a window for example. The headrail 150 preferably weighs 0.52 pounds or less per linear foot and the valence 130 preferably weighs 0.26 pounds or less per linear foot. The overall weight for the shutter system 101 with a valence 130 having a height of 7 feet and an overall width of 7 feet is preferably less than 82 pounds.

FIG. 6 is a cross-sectional, side view of the preferred embodiment of the shutter and the headrail when the louvers are open. As the louvers 110 open, the tabs 113 engage with the tilt rod 115 to urge the tilt upward and toward window 156.

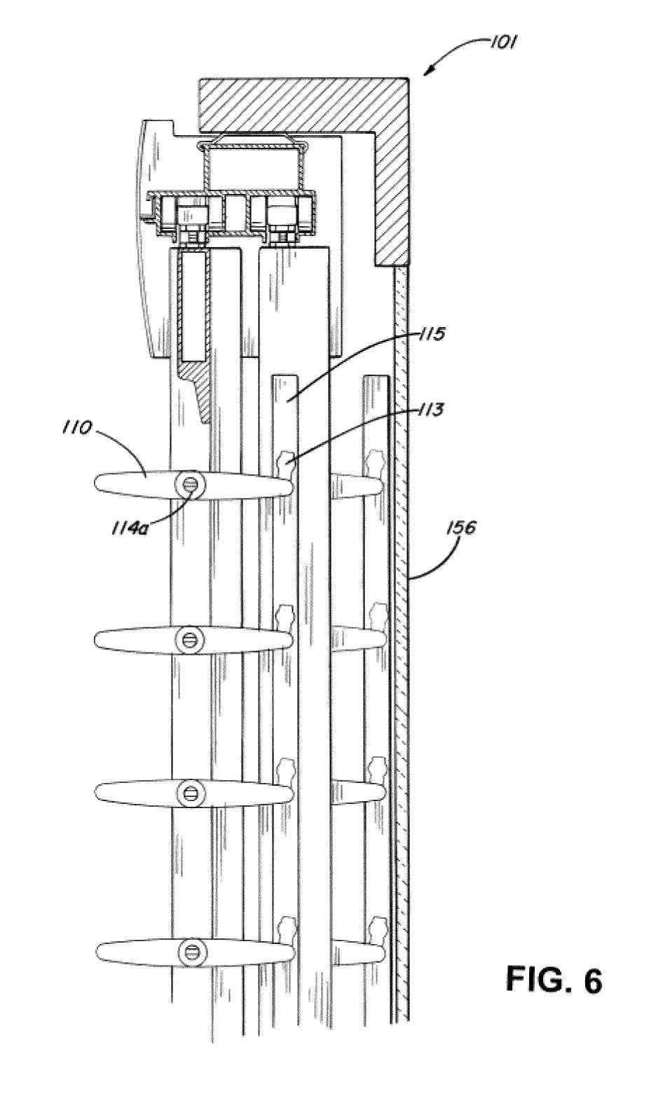

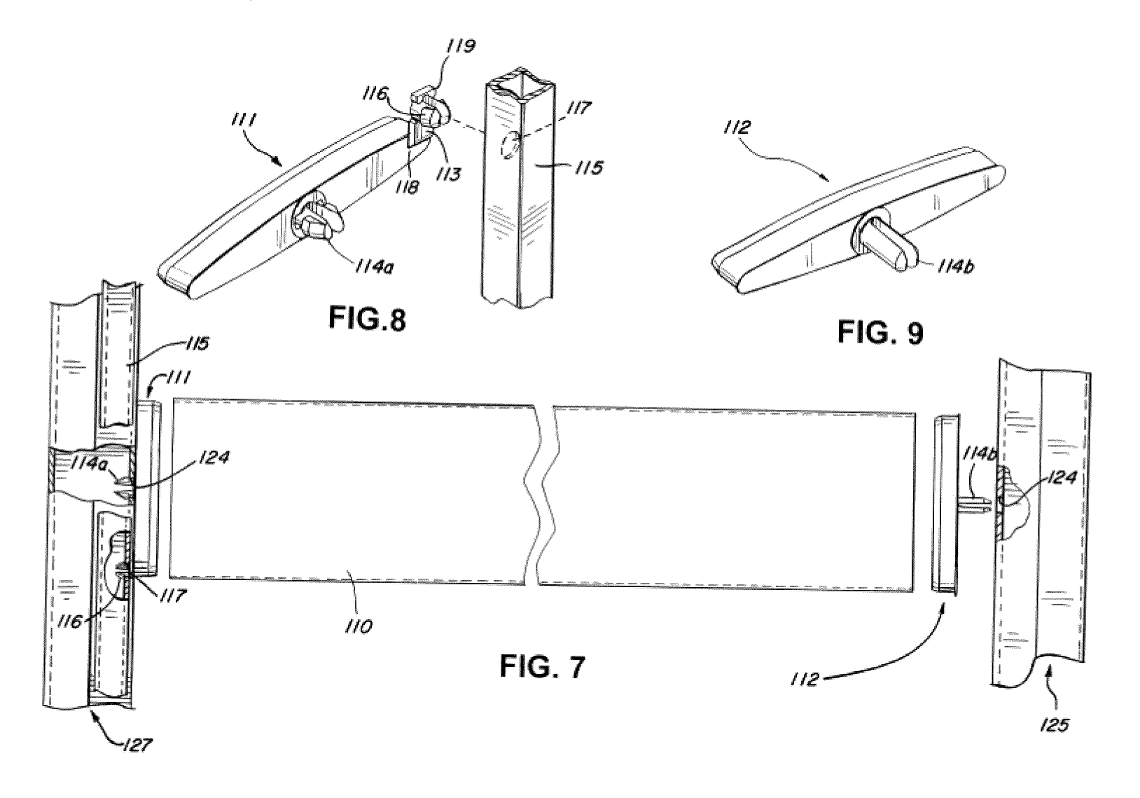

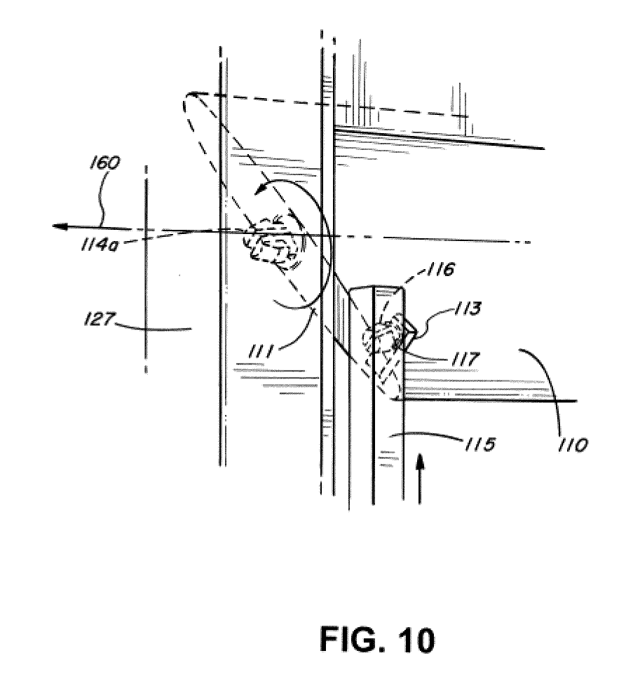

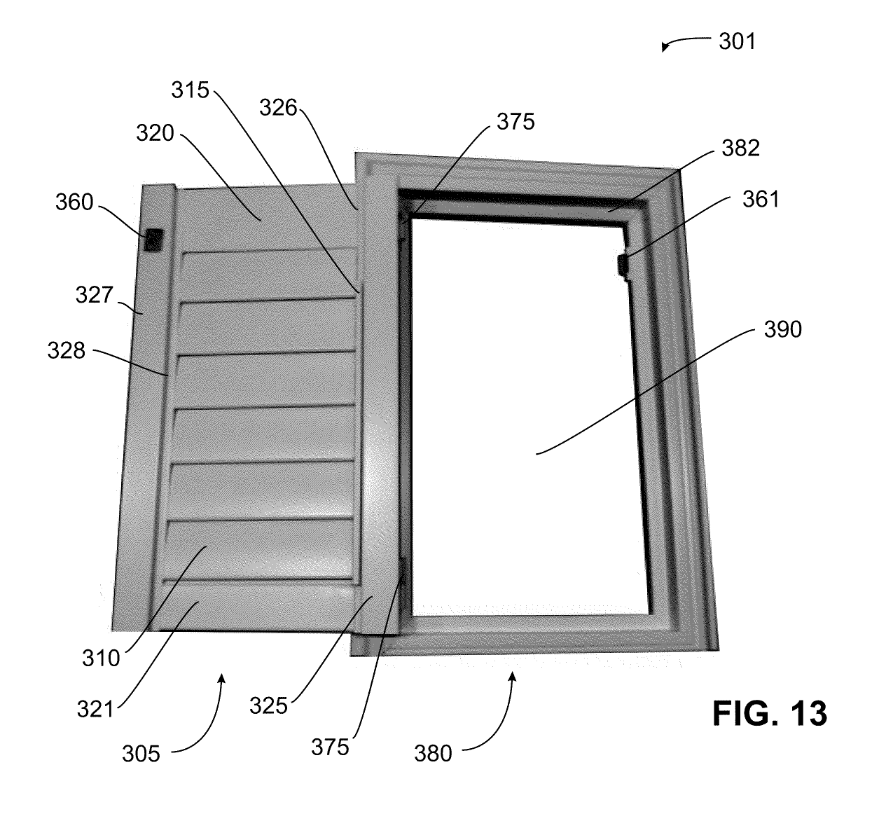

FIGS. 7-10 illustrate the preferred coupling and operation of louvers 110 and the tilt rod 115 in a preferred shutter assembly which can be used in connection with or without a headrail or can be used with a frame 380 depicted in FIG. 13 and discussed below. FIG. 7 is a top view of a preferred embodiment of a louver 110. Louver 110 has a single male connector louver endcap 112 at one end of the louver 110 and a dual male connector louver endcap 111 at the opposite end of the louver 110. As depicted in FIGS. 7 and 9, the single male connector louver end cap 112 has a centrally-located pin 114b that protrude away from the dual male connector louver endcap 112 in a direction substantially parallel to the louver's axis of rotation 160 as depicted in FIG. 10. Stile 125 has a plurality of stile holes 124 which are configured for receiving the corresponding centrally-located pins 114b from the single male connector louver endcap 112. Centrally-located pin 114a preferably has two members, or arms, which diverge after entering stile hole 124 to eliminate excessive play between the pin 114a and the holes 124.

As depicted in FIGS. 7 and 8, each dual male connector louver endcap 111 comprises a centrally-located pin 114a that protrudes away from the dual male connector louver endcap 111 in a direction substantially parallel to the louver's axis of rotation 160. The stile 127 has a plurality of holes 124 which are configured for receiving the corresponding centrally-located pins 114a from the dual male connector endcap 111. Centrally-located pin 114b preferably has two sections, or arms, which diverge and have a rib structure which eliminates excessive play and locks the pin 114a within the holes 124. The louvers 110 pivot about pins 114a and 114b as the louvers are opened or closed.

The dual male connector louver endcap 111 also has a tab 113 at a distal end 118 that extends in a direction away from the louver 110. The tab 113 has an extension 119 and a tension pin 116 which is located away from the louver 110 and protrudes perpendicularly to the extension (3) and away from the dual male connector louver endcap 111 in a direction that is substantially parallel to the louver's axis of rotation 160.

Referring to FIGS. 8 and 10, the tilt rod 105 has a plurality of tilt rod holes 117 which are configured for receiving the corresponding tension pins 116 from the dual male connector endcap 111. Each tension pin 116 preferably comprises two diverging sections each having a rib, or ratchet, which eliminates excessive play and locks the tension pin 116 within the tilt rod holes 117. As the louvers 110 open and pivot about the centrally-located pins 114a and 114b, the tabs 113 on the dual male connector louver endcaps 111 move the tilt rod 115 vertically. The tilt rod 115 is displaced vertically when the louvers are placed in an open position. The tilt rod 115, the single male connector louver endcap 112, the dual male connector louver endcap 111, and the stile holes 124 are configured to create tension in the louvers 110 such that the louvers 110 remain in the desired position but can be easily opened or closed.

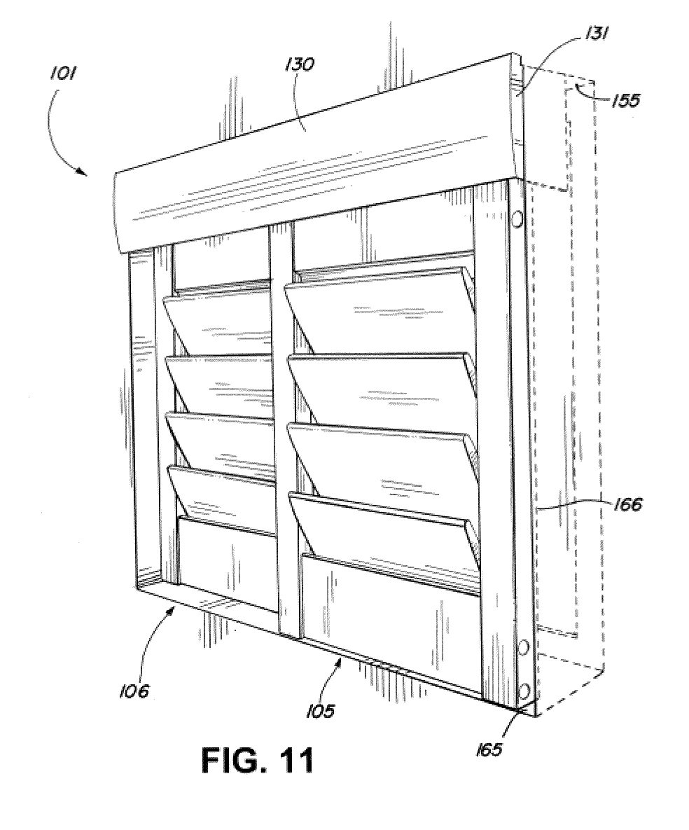

It will be appreciated that the combination of a slim overall depth of the system 101 and a light overall weight enables the system 101 to be installed in an inside window opening 165 as shown in FIG. 11. Unlike traditional shutter assemblies which require an outside window mount, the preferred shutter system 101 can be coupled to the top surface of an inner window mount, or the window jamb 155 as depicted in FIG. 5, such as with clips or conventional window-treatment mounting brackets 154 depicted in FIG. 5 commonly used in installing conventional blinds. The valence 130 and the outer shutter assembly 105 may project partially beyond the adjacent wall surface 166 in an embodiment. The outer shutter assembly may be flush with the adjacent wall 166 surrounding the wall opening 165 in another embodiment.

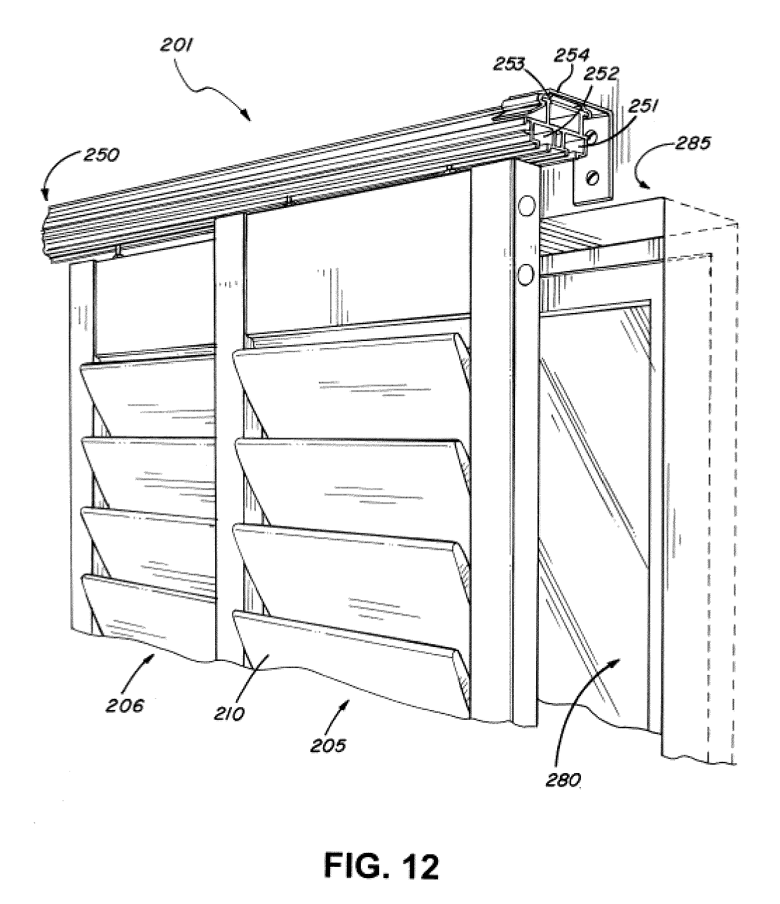

FIG. 12 is a front (interior facing) perspective drawing of a preferred embodiment of a shutter apparatus 201 mounted outside a sliding glass door 280. The shutter apparatus has a headrail 250, an inner shutter assembly 206, and an outer shutter assembly 205. A valance which covers headrail 250 has been omitted in FIG. 12 for clarity. Both shutter assemblies 205 and 206 have a plurality of louvers 210. The headrail 250 has an inner track 251 and an outer track 252. The inner shutter assembly 206 is slideably coupled to the inner track 251 and the outer shutter assembly 205 is slideably coupled to the outer track 252. The headrail 250 has a mounting track 253 which is configured to be mounted into a conventional window-treatment mounting bracket 254. The conventional window-treatment mounting bracket 254 is secured into the wall 285 above the sliding glass doors 280.

The conventional window-treatment mounting bracket 254 may be a mounting bracket used to install venetian blinds, vertical blinds, horizontal blinds, and mini blinds. As such, the shutter apparatus 201 may be used to retrofit into existing window treatments including, but not limited to, venetian blinds, vertical blinds, horizontal blinds, and mini blinds.

FIG. 13 is a front (interior facing) perspective drawing of an embodiment of a shutter assembly 305 pivotly coupled to a frame 380 in front of an opening 390. Shutter system 301 comprises a shutter assembly 305, a frame 380, and one or more hinges 375 which pivotly couples the shutter assembly 305 to the frame 380. Shutter assembly 305 has stiles 327 and 325 which are coupled together by a top rail 320 and a bottom rail 321. Stile 325 has a rabbet, or recessed shoulder, 326 immediately adjacent to the louvers 310. Stile 327 may have a rabbet 328 located immediately adjacent to the louvers 310. Louvers 310 are pivotly coupled to stiles 325 and 327. Each louver 310 is coupled to a tilt rod 315. When the louvers 310 are in a closed position, the tilt rod 315 nests in rabbet 326 such that tilt rod 315 is flush with, or recessed within, the back surface of stile 325.

The hinges 375 pivotly couples the shutter assembly 305 to the frame 380. When the shutter assembly 305 is in a closed position, the shutter assembly 305 nests within the recessed shoulder 382 of the frame 380. The metal bracket 360 on the shutter assembly 305 is secured in a closed position by magnet 361 on the inner surface of the frame 380.

Although the invention has been discussed with reference to specific embodiments, it is apparent and should be understood that the concept can be otherwise embodied to achieve the advantages discussed. The preferred embodiments above have been described primarily as light-weight, narrow-profile sliding shutter systems that are configured for mounting indoors using conventional vertical blind brackets common in homes and offices. In this regard, the foregoing description of the system and methods is present for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

What is claimed is:

1. A shutter system comprising:
a headrail having an inner track and an outer track, wherein the headrail is configured for mounting indoors;
an inner shutter assembly having a plurality of first louvers, wherein the inner shutter assembly is slideably coupled to the inner track;
an outer shutter assembly having a plurality of second louvers, wherein the outer shutter assembly is slideably coupled to the outer track;
wherein the inner shutter assembly and the outer shutter assembly are configured for moving past each other when the first louvers and the second louvers are placed in a closed position.

2. The shutter system of claim 1, wherein the headrail, the inner shutter assembly, and the outer shutter assembly are configured for installing within a conventional window opening.

3. The shutter system of claim 1, wherein the overall depth of the inner shutter assembly and the outer shutter assembly is approximately 2.5 inches or less.

4. The shutter system of claim 1, wherein the headrail is further configured for mounting in a conventional vertical blind bracket.

5. The shutter system of claim 1, wherein:
the headrail further comprises an extruded aluminum member; and
the inner and outer shutter assemblies further comprise extruded plastic members.

6. The shutter system of claim 5, wherein the plastic members further comprise polyresin members.

7. The shutter system of claim 6, wherein the inner and the outer shutter assembly have a weight in the range of approximately 1.2 pounds/foot² to approximately 2 pounds/foot² of facial area of a front surface of the inner or outer shutter assemblies.

8. The shutter system of claim 1, further comprising
two carrier assemblies coupled to the inner shutter assembly and configured for riding in the inner track, wherein the two carrier assemblies have a plurality of wheels configured for riding on the lowermost portion of the inner track; and,
two additional carrier assemblies coupled to the outer shutter assembly and configured for riding in the outer track, wherein the two additional carrier assemblies have an additional plurality of wheels configured for riding on the lowermost portion of the outer track

9. The shutter system of claim 1, further comprising a valance configured for coupling to the headrail.

10. The shutter system of claim 1, wherein the headrail is further configured for mounting in a conventional window-treatment mounting bracket.

11. The shutter system of claim 1, wherein no hinge is coupled to the inner shutter assembly or the outer shutter assembly.

12. The shutter system of claim 1, wherein no frame is coupled to the inner shutter assembly or the outer shutter assembly.

13. A shutter assembly comprising:
a plurality of louvers, wherein:
each louver is configured for rotating about an axis of rotation,
each louver has a single male connector louver endcap at one end of said each louver and a dual male connector louver endcap at the opposite end of said each louver,
each male connector pin louver endcap comprises a first centrally-located pin protruding away from said each louver in a first direction substantially parallel to the axis of rotation,
each dual male connector louver endcap comprises a second centrally-located pin protruding away from said each louver in a second direction opposite the first direction substantially parallel to the axis of rotation,
said each dual male connector louver endcap further comprises a tab at a distal end of said dual male connector louver endcap extending away from the louver,
said each tab further comprises a tension pin positioned away from the louver and protruding away from said each louver in the second direction;
a shutter frame comprising:
a top rail,
a bottom rail,
a first stile having a plurality of stile holes configured for receiving corresponding first centrally-located pins from said each single male connector louver endcap,
a second stile having a plurality of additional stile holes configured for receiving corresponding second centrally-located pins from said each dual male connector louver endcap; and,
a tilt rod having a plurality of tilt rod holes configured for receiving corresponding tension pins from said each dual male connector louver endcap.

14. The shutter assembly of claim 13, wherein:
said second stile has rabbet on a surface adjacent to the dual male connector louver endcaps, and,
said rabbet is configured for nesting the tilt rod when the louvers are closed.

15. The shutter assembly of clam 14, wherein the tilt rod is flush with the surface adjacent to the dual male connector louver endcaps when the louvers are closed.

16. The shutter assembly of claim 13, wherein the single male connector louver endcap, the dual male connector louver endcap, the first and second stiles, and the tilt rod are configured for securing the louvers in a desired position and allowing the louvers to be manually adjusted.

17. The shutter assembly of claim 13, wherein the depth of the shutter assembly is approximately 1.125 inch or less.

18. The shutter assembly of claim 13, wherein the louvers and the shutter frame comprise hollow extruded plastic members.

19. The shutter assembly of claim 18, wherein the extruded plastic members comprise extruded polyresin members.

20. The shutter system of claim 19, wherein the shutter assembly has a weight in the range of approximately 1.2 pounds/foot2 to approximately 2 pounds/foot2 of facial area of a front surface of the shutter assembly.

21. A shutter system comprising:
a headrail having an inner track, an outer track, and a mounting rail, wherein the headrail is configured for mounting as an inside window mount;
an inner shutter assembly comprising:
a first shutter frame having a first set of two stiles,
a plurality of first louvers rotatably mounted in the first shutter frame,
a first tilt rod coupled to the plurality of first louvers, wherein the first tilt rod is configured for setting a tilt of the plurality of first louvers,
a first carrier assembly coupled to the first shutter frame and configured for riding in the inner track;
an outer shutter assembly comprising:
a second shutter frame having a second set of two stiles,
a plurality of second louvers rotatably mounted in the second shutter frame,
a second tilt rod coupled to the plurality of second louvers, wherein the second tilt rod is configured for setting a tilt of the plurality of second louvers,
a second carrier assembly coupled to the second shutter frame and configured for riding in the outer track;
wherein the inner shutter assembly and the outer shutter assembly are configured for moving past each other when the plurality of first louvers and the plurality of second louvers are placed in a closed position.

22. The shutter system of claim 21, wherein:
at least one of the first set of two stiles has a first rabbet on a surface adjacent to the plurality of first louvers, wherein the first rabbet is further configured for nesting the first tilt rod when the plurality of first louvers are closed; and
at least one of the second set of two stiles has a second rabbet on a surface adjacent to the plurality of second louvers, wherein the second rabbet is further configured for nesting the second tilt rod when the plurality of second louvers are closed.

23. The shutter system of claim 21, wherein the headrail, the inner shutter assembly, and the outer shutter assembly are configured for fitting within a conventional window opening.

24. The shutter system of claim 21, wherein no hinge is coupled to the inner shutter assembly or to the outer shutter assembly.

25. The shutter system of claim 21, wherein no frame is coupled to the inner shutter assembly or to the outer shutter assembly.

26. A shutter apparatus comprising:
a headrail having an inner track and an outer track, wherein the headrail is configured for coupling to one or more conventional window-treatment mounting brackets;
an inner shutter assembly having a plurality of first louvers, wherein the inner shutter assembly is slideably coupled to the inner track;
an outer shutter assembly having a plurality of second louvers, wherein the outer shutter assembly is slideably coupled to the outer track;
wherein the headrail, the inner shutter assembly, and the outer shutter assembly are configured for retrofitting into an existing window-treatment.

27. The shutter apparatus of claim 26 wherein:
the conventional window-treatment mounting brackets comprise vertical blind mounting brackets; and
the existing window-treatment comprises an existing vertical blind.

28. The shutter apparatus of claim 26 wherein the existing window treatment comprises a window treatment for a sliding glass door.

29. The shutter apparatus of claim 26 wherein the existing window treatment comprises a window treatment for a window.
